(19) United States
(12) Patent Application Publication
(10) Pub. No.: US 2004/0022071 A1
(43) Pub. Date: Feb. 5, 2004

(54) Optical energy collection system to provide economical light source

(75) Inventors: Bruce C. H. Cheng, Taipei (TW); Guan-Jey Leu, Taipei (TW); Mao-Cheng Weng, Taipei (TW); Yin - Yuan Chang, Taipei (TW)

Correspondence Address: Bo-In Lin, 13445 Mandoli Drive, Los Altos Hills, CA, 94022, US

(73) Assignee: DELTA ELECTRONIC, INC.

(21) Appl. No.: 10/431,111

(22) Filed: May 8, 2003

Related U.S. Application Data
(60) Provisional application No. 60/400,846, filed on Aug. 2, 2002.

(51) Int. Cl. F21V 7/04

(52) U.S. Cl. 362/557; 362/228

(57) ABSTRACT

The present invention discloses an optical energy collecting system for providing optical power to a display system for showing an image. The optical energy collection system includes an optical energy collecting system for collecting optical energy from a background illumination source surrounding and illuminating on the display system whereby an optical energy provided by said optical energy collecting system to said display system for illumination is naturally adjusted according to a background illumination of the background illumination source surrounding the display system.

This Application claims a Priority Filing Date of Aug. 2, 2002 benefited from a previously filed Application 60/400,846 filed by the same inventors of this Application.

### BACKGROUND OF THE INVENTION

1. Field of the Invention

This invention relates generally to light source for illumination and display system. More particularly, this invention relates to an improved light collection system for collecting and filtering optical energy from solar and different complimentary light sources to economically provide optical powers to the display or illumination systems at different time of the day with minimum wastes while accommodate comfortable viewing with brightness adjustments depending on viewer's background illumination.

2. Description of the Prior Art

FIG. 5 is a functional block diagram for showing an optical energy collecting system for implementation in a common display light projection (DLP) engine 200. An optical energy collector includes a lamp 205 projects light onto an elliptic reflector 210 for reflecting and focusing the reflected light onto an integration tunnel 220 covered by a color wheel 230 to function as a color light source. The color light is projected through a set of ray lenses 235 and field lens 240 on to a total internal reflection (TIR) prism 245 in combination with a digital modulation display (DMD) panel 250 to generate image source for projecting through a projection lens 260 of a color image display system.

A technical difficulty is still faced by those of ordinary skill the art of designing and making outdoor display systems for providing a light source suitable for different times of the day and varying background brightness situations. In the daytime of a sunny day, due to the very high intensity of illumination from the sun, a light source of high intensity is required to overcome the degradation of image display caused by the bright background. However, such strong light source would become too bright in the evening. Adjustments to the light source are necessary to provide comfortable viewing of an outdoor display. Additional sensing of the background light to adjust the intensity of the light source would be required. Furthermore, in order to overcome the high illumination of the sun, a high power light source would also be required. These requirements add to the cost and operational complexities of an outdoor display system. Additionally, a light source of high intensity often leads to other design concerns, such as light source overheating and other safety issues. These difficulties often limit a more effective applications of the outdoor display systems utilizing digital display technologies that can provide many different kinds of advantages over image displays implemented with conventional technologies.

Therefore, an improved light source, particularly for outdoor digital image display, is still required to overcome these difficulties and limitations. It is desirable that such light source has an optical energy collecting system that can directly collecting the light from sun light such that the brightness of the display can be made substantially proportional to the background light. It is further desirable to take advantage of the sensing feature in collecting the solar energy to provide complimentary optical energy based on the sensed solar power collected by an outdoor solar light collector.

### SUMMARY OF THE PRESENT INVENTION

It is therefore an object of the present invention to provide an optical energy collection system for directly collecting optical energy from background illumination such that the intensity of the light source would substantially change in proportional to the background illumination such that the above-mentioned difficulties can be resolved.

Specifically, it is an object of the present invention to provide an economical and highly functional sunlight energy collection system to collect solar energy and to filter and focus the sunlight into visible light source for image display system. Since the intensity of the light source would substantially proportional to the background illumination when the sunlight is focused and transmitted to a light source for a display system, the light source is most useful for outdoor large display. As the sunlight is strong and the background illumination is high, the light source is also providing high intensity image display. A comfortable viewing is provided without unnecessary wastes of illumination energy.

Another object of the present invention is to provide a novel light source for a display system where the light source is complimented between a sunlight optical energy collector and lamp light collector such that the intensity of the light source for an image display system can be flexibly controlled to achieve optimal illumination intensity for comfortable viewing. The complimentary light source can be conveniently employed when the sunlight is dimmed during a cloudy day or after the sunset such that an outdoor display can be comfortably viewed during a high illumination and after-dark conditions.

Another object of the present invention is to provide a visible light source from the sunlight radiations by first filtering the ultraviolet and infrared lights from the optical energy collected by the light collecting system of this invention. The invisible and potentially healthy hazardous radiations can be removed without being unduly applied in an image display system to further enhance the functionality and usefulness of the economical and environmentally sound display system.

Briefly, in a preferred embodiment, the present invention discloses an optical energy collecting system for providing optical power to a display system for showing an image. The optical energy collection system includes an optical energy collecting system for collecting optical energy from a background illumination source surrounding and illuminating on the display system whereby an optical energy provided by said optical energy collecting system to said display system for illumination is naturally adjusted according to a background illumination of the background illumination source surrounding the display system.

In a preferred embodiment, this invention further discloses a method for collecting optical energy for providing optical power to a display system for showing an image. The method includes a step of collecting optical energy from a background illumination source surrounding and illuminating on the display system by employing an optical energy collecting system whereby an optical energy provided by the optical energy collecting system to the display system for illumination is naturally adjusted according to a background illumination of the background surrounding the display system.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1a is a functional block diagram showing an optical energy collecting system of this invention for collecting optical energy from a background illumination source such as the sunlight;

FIG. 1b is a schematic diagram for showing an optical energy collecting system from background light source such as sunlight with a Frensel lens of this invention

FIG. 1c is a schematic diagram of a Frensel lens.

FIG. 2 is a schematic diagram showing another optical energy collecting system of this invention for collecting optical energy in parallel from a background illumination source such as the sunlight;

FIG. 3 is a schematic diagram showing another optical energy collecting system of this invention for collecting optical energy from a background illumination source such as the sunlight and a complementary light source employing a lamp;

FIG. 4 is a schematic diagram showing an optical energy collecting system of this invention for collecting optical energy from a background illumination source such as the sunlight and distribute the light to a plurality of optical output ports;

FIG. 5 is a schematic diagram showing an optical energy collecting system of the prior art employing a lamp wherein the optical energy collecting system serves as a DLP engine for a color image display system;

FIG. 6 is a schematic diagram showing an optical energy collecting system of this invention for collecting optical energy from sunlight wherein the optical energy collecting system serves as a DLP engine for a color image display system;

FIG. 7 is a schematic diagram showing an optical energy collecting system of this invention for collecting optical energy from sunlight and lamp wherein the optical energy collecting system serves as a DLP engine for a color image display system;

FIG. 8 is a schematic diagram showing an optical energy collecting system of this invention for collecting optical energy from multiple lamps wherein the optical energy collecting system serves as a DLP engine for a color image display system;

FIG. 9a is a schematic diagram showing an optical energy collecting system of this invention for collecting optical energy from sunlight and color separate the sunlight into RGB color components wherein the optical energy collecting system serves as a DLP engine for a color image display system;

FIG. 9b is a schematic diagram for showing a cladding rod;

FIG. 9c is a schematic diagram for showing a fiber rod;

FIG. 10a shows a perspective view of a sunlight tracking system for tracking and rotating a sunlight collector to direct to the sun for maximizing efficiency of sunlight collection;

FIG. 10b is a schematic diagram for showing a Frensel lens, a mirror with a rotational center and a cladding rod, e.g. an optical rod with the Frensel lens converges the sunlight to the mirror and reflects the sunlight to the fiber rod;

FIG. 10c is a schematic diagram for showing the angle between the sunlight and mirror;

FIG. 10d is a schematic diagram for showing the different position of FIG. 10b;

FIG. 10e is a schematic diagram for showing the angular position of the mirror at noon time;

FIG. 10f is a schematic diagram for showing the Frensel lens rotates Δφ, while the angle Γ₀′ between the mirror and the focused beam projected from the edge of the Frensel lens must be greater than zero degree;

FIG. 11 is a schematic diagram for illustrating a sunlight regulating system of this invention; and

FIG. 12 is a schematic diagram for illustrating a mobile outdoor display system of this invention implemented with a sunlight collecting system as shown in FIGS. 1 to 11 but FIG. 5.

### DETAILED DESCRIPTION OF THE PREFERRED EMBODIMENT

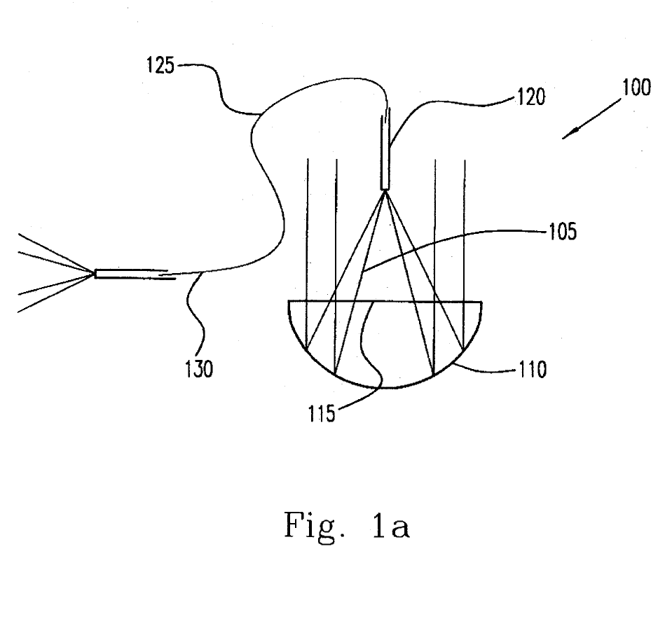

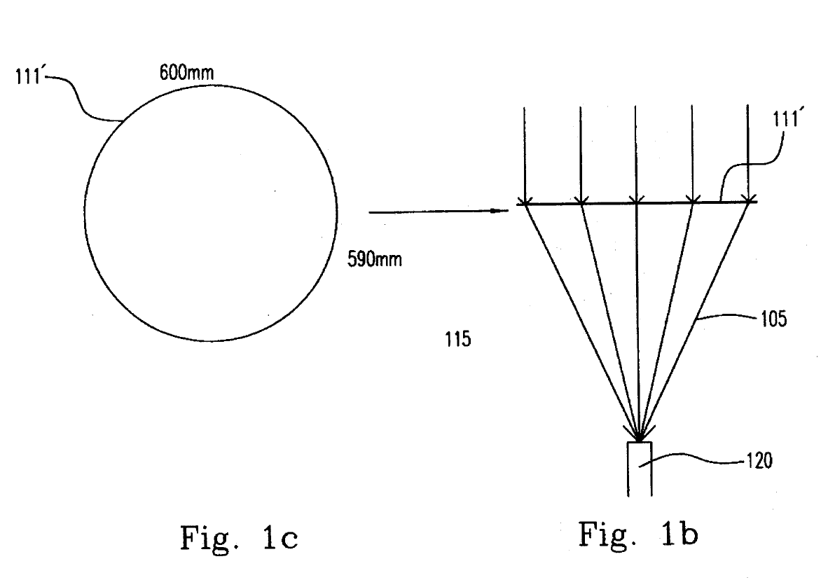

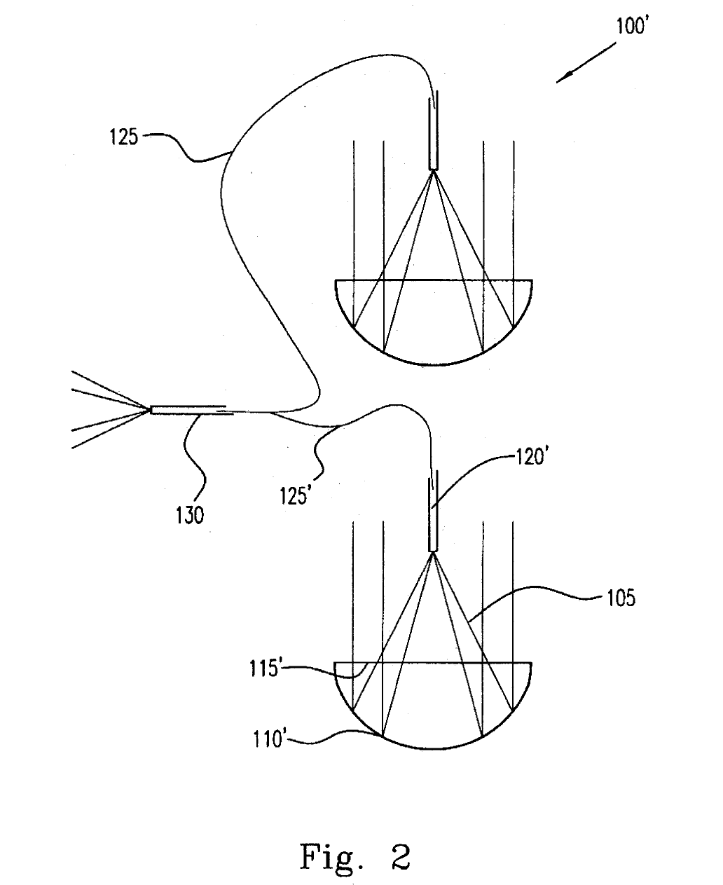

FIG. 1a is a schematic diagram showing an optical energy collecting system 100 of this invention for collecting optical energy from a background illumination source, e.g., the sunlight 105. The optical energy collecting system 100 includes a parabolic reflector 110 for reflecting and focusing the sunlight 105 onto an optical fiber 120 through an ultraviolet (UV) and infrared (IR) filter 115 to filter out the invisible light before the reflected light is focused onto the optical fiber 120. The filtered light with only the visible light then transmitted from the optical fiber 120 through a waveguide or an optical fiber extension 125 to an optical output port 130. FIG. 1b shows another embodiment by using a Frensel lens instead of the parabolic reflector as shown in FIG. 1a. The Frensel lens 111′ focuses the incident sunlight 105 onto an optical fiber 120. Specifically, as shown in FIG. 1c, the Frensel lens 111′ has a width of 600 millimeters and a length of 590 millimeters, the Frensel lens 110′ has a focal length of 706 millimeters. FIG. 2 is another functional block diagram for showing an alternate optical energy collecting system 100′ similar to that shown in FIG. 1 except that there are two parallel parabolic reflectors 110 and 110′ to collect the sunlight through optical fibers 120 and 120′. The collected and filtered visible light is then transmitted through the optical fiber extensions 125 and 135′ to an output port 130.

Table 1 shows the optical energy collection during different times of the day where the illumination in the unit of “Lux” is measured by a illumination sensor Minolta T-10. From Table 1, the optical power provided to a display system during different times of a day is substantially changed in proportional to the brightness of the background. Therefore, a comfortable viewing of an outdoor display can be achieved without wastes of employing optical source of great power for the purpose of overcoming a strong background illumination when there is a strong sunlight.

TABLE 1
Optical Energy Collection during different times of a Day

| Time | 9:00 | 10:00 | 11:00 | 12:00 | 13:00 | 14:00 | 15:00 | 16:00 | 17:00 |
|---|---|---|---|---|---|---|---|---|---|
| Temperature | | | | | | | 32C | | |
| Humidity | | | | | | | 35C | | |
| Illumination- | 56600 | 69800 | 79900 | 81600 | 89000 | 86500 | 82400 | 58000 | 31700 |
| Inclined to | | | | | | | | | |
| Sun (Lux) | | | | | | | | | |
| Illumination- | 49500 | 65600 | 75200 | 81400 | 82000 | 71000 | 60000 | 36100 | 14630 |
| Horizontal | | | | | | | | | |
| (Lux) | | | | | | | | | |

Where 56600 lux×1 m² (area)=56600 lum˜870W UHP lamp. And UHP 65 lum/W (100 W UHP˜6500 lm).

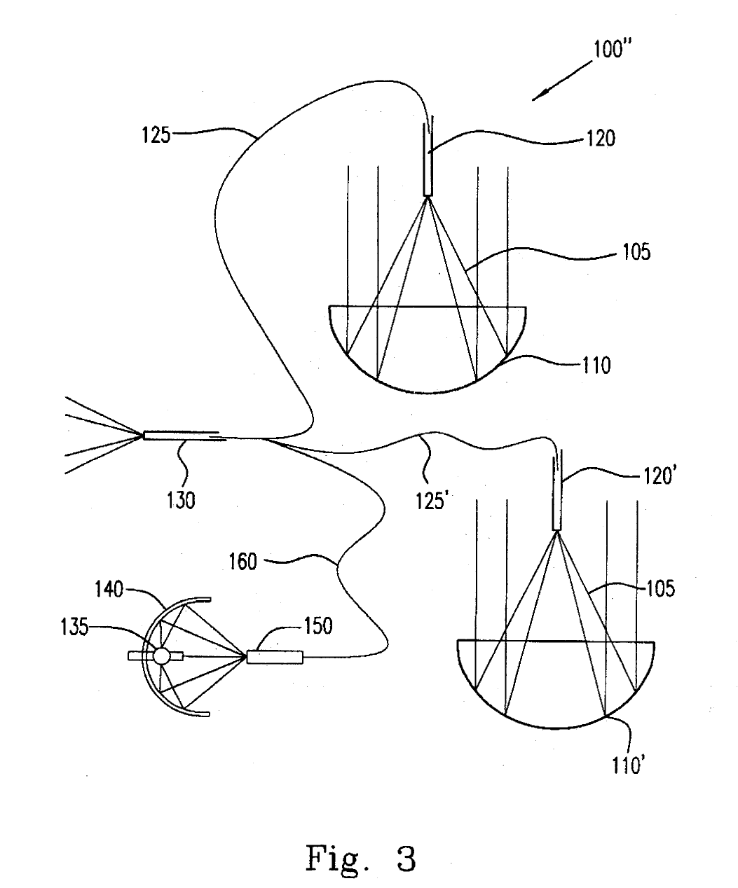

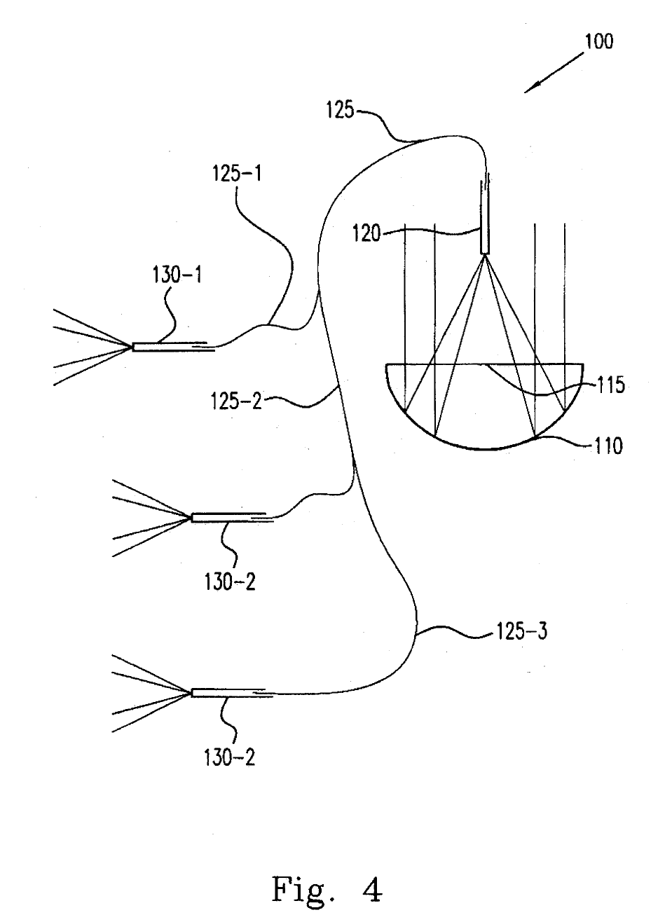

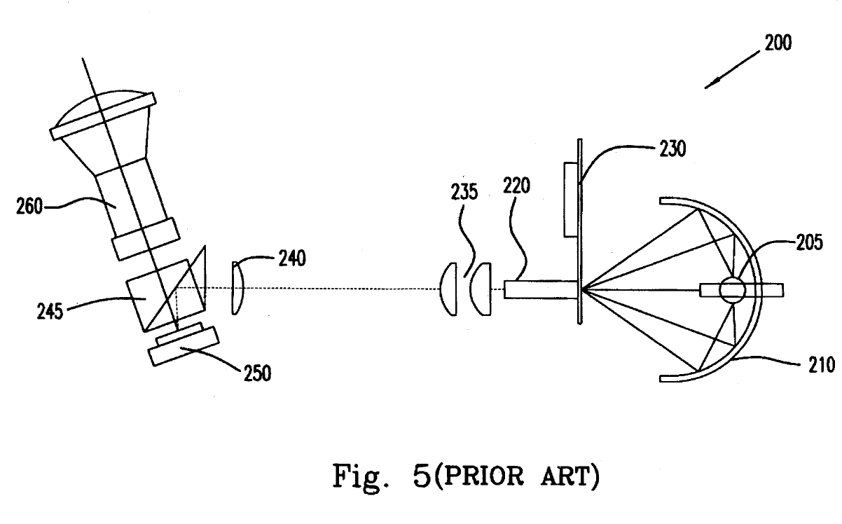

FIG. 3 is another schematic diagram for showing an alternate optical energy collecting system 100″ similar to that shown in FIG. 1 except that there are two parallel parabolic reflectors 110 and 110′ and also a lamp 135 serving as a complimentary light source to project light onto an elliptic reflector 140 for reflecting and focusing the light onto an optical fiber 150 for transmitting the reflected light to the optical output port 130. FIG. 4 is another schematic diagram for showing the optical energy collecting system 100 similar to that shown in FIG. 1 except that there are the extended optical fiber 125 is now separated into three optical fibers 125-1, 125-2, and 125-3 for providing light source to three optical output ports, 130-1, 130-2, and 130-3.

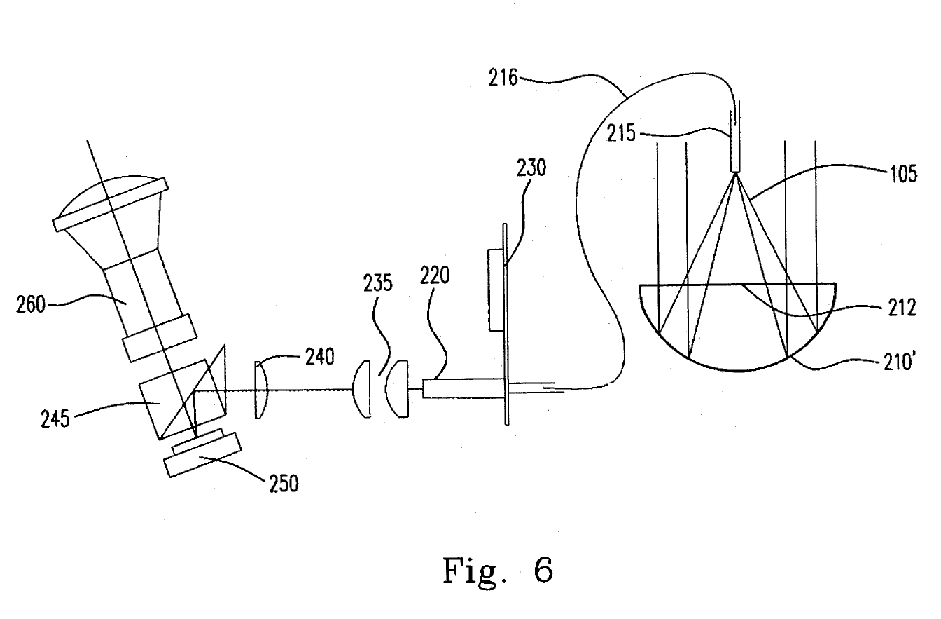

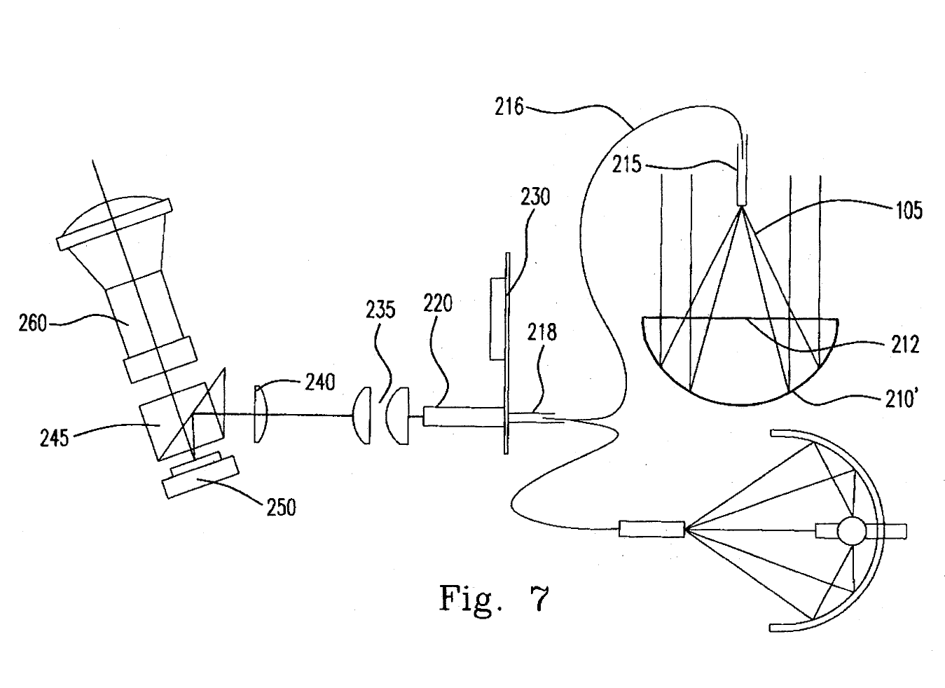

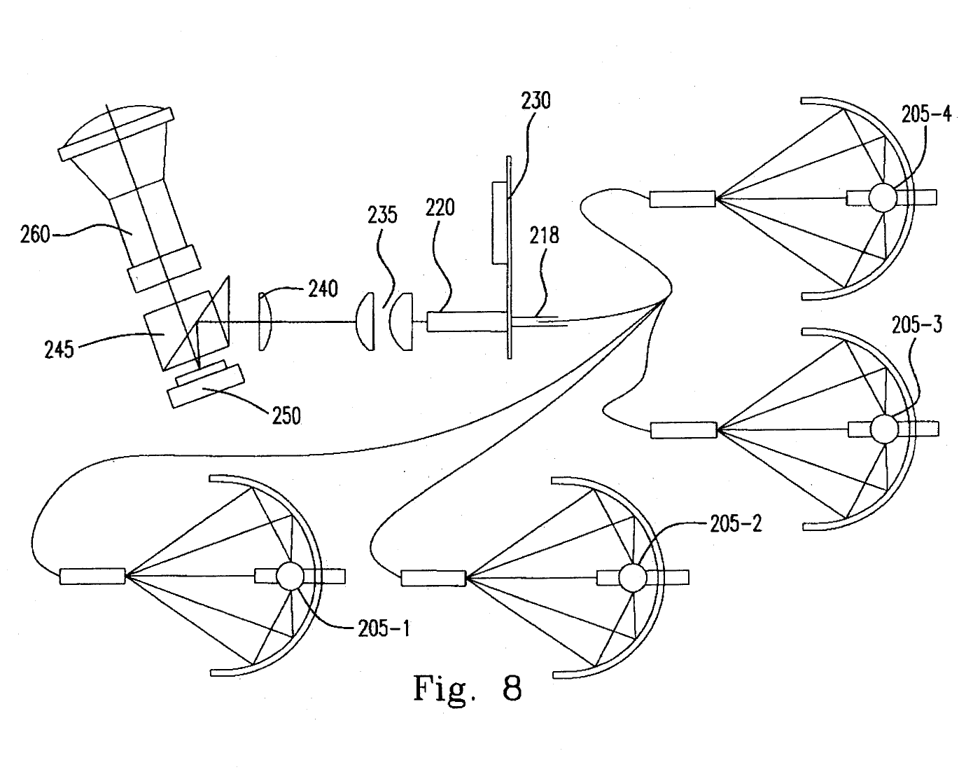

FIG. 6 is a schematic diagram for showing an alternate optical energy collecting system, for implementation in an identical digital light processing (DLP) engine 200′. Instead of employing a lamp as light source, the optical energy collection system is a solar optical energy light collector that includes a parabolic reflector 210′ to reflect and focusing sunlight through an UV and IR filter 212 into an optical fiber 215 for transmitting the filtered visible light to an optical fiber port 218 disposed immediately next to the integration channel 220. FIG. 7 shows a novel engine collecting optical energy from the sunlight by the parabolic reflector 210′ and the elliptic reflector 210 from the lamp that functions as a complimentary light source. FIG. 8 shows an DLP engine of this invention and the optical energy is collected from a multiple light sources in parallel using a plurality of lamps, e.g., lamps 205-1, 205-2, 205-3, and 205-4, as light sources, to function as a combined light source for the display system. This DLP engine is intended for use in compliment to the sunlight energy collector during a cloudy day when the sunlight is weak or not available.

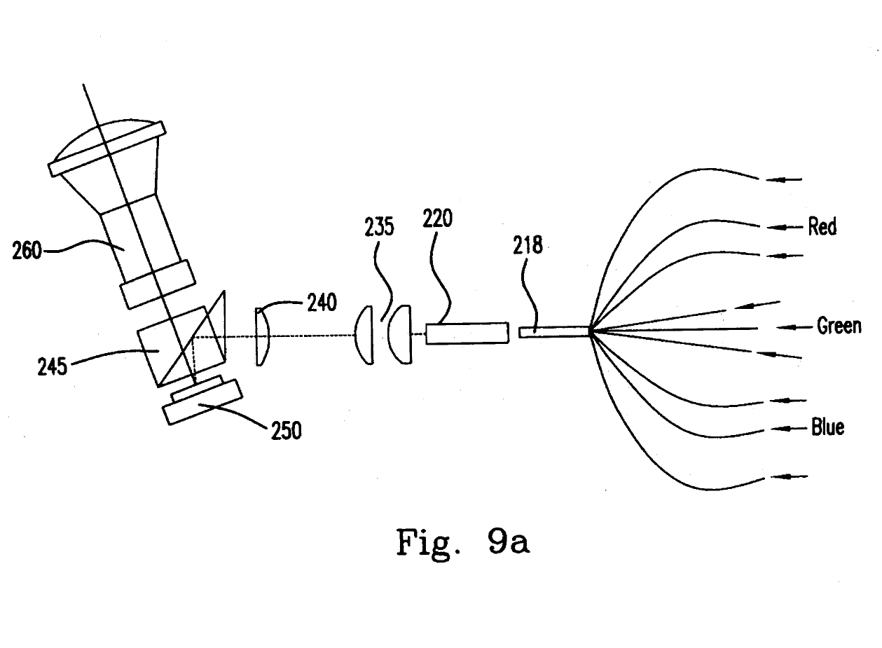

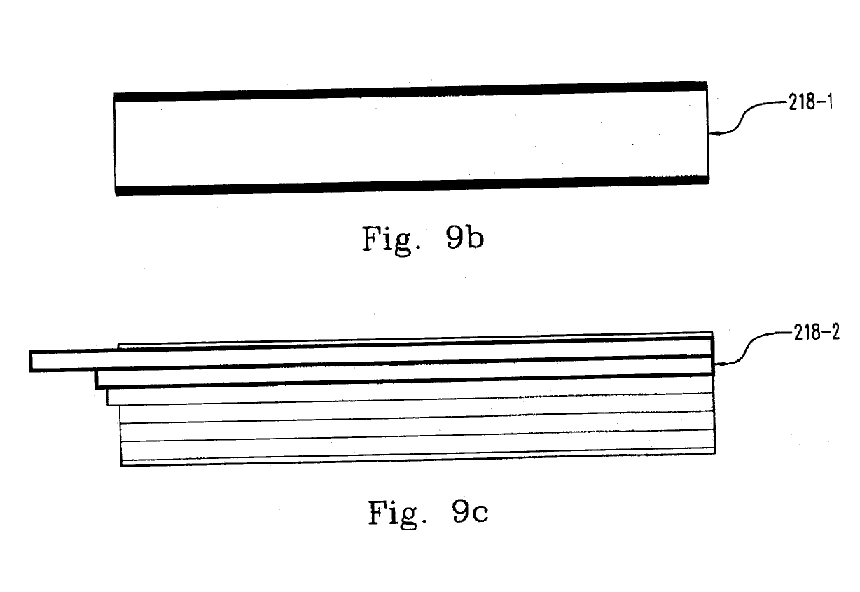

FIG. 9a is another schematic diagram for illustrating the configuration of another DLP engine where the light collected from the sunlight collector as shown in FIGS. 1 to 4 are processed by a laser diode (LD) or light emission diode (LED) module for projecting red, green and blue lights (RGB) onto a fiber 218 disposed immediately next to the integration channel to provide color lights to the display projection system. FIGS. 9b and 9c show a single core single cladding optical fiber 218-1 and a multi-core, multi-cladding optical fiber 218-2 respectively implemented for the fiber 218-1 of FIG. 9a.

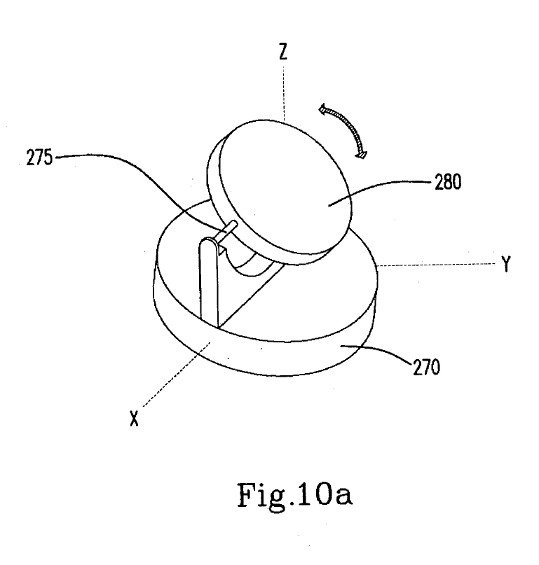

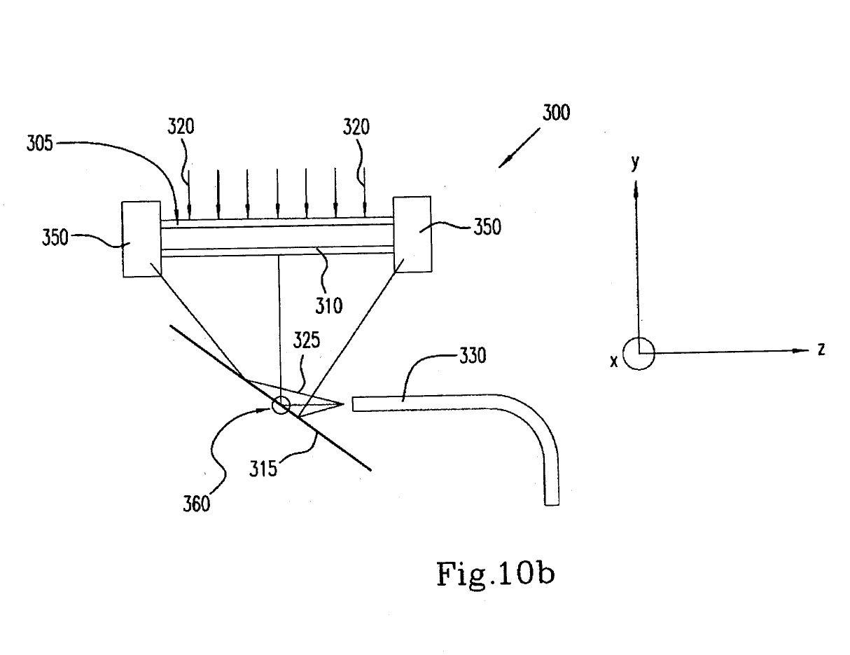

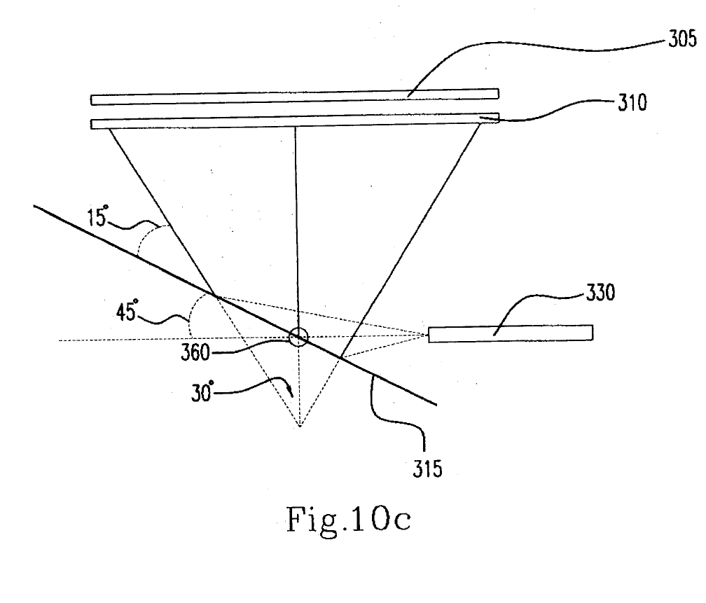

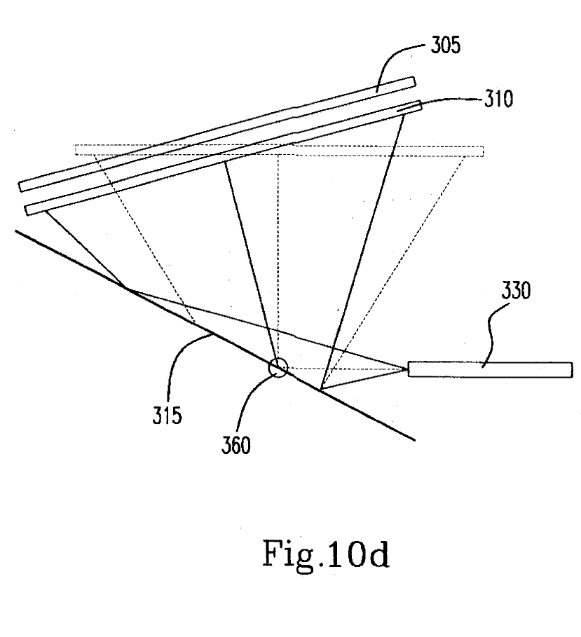

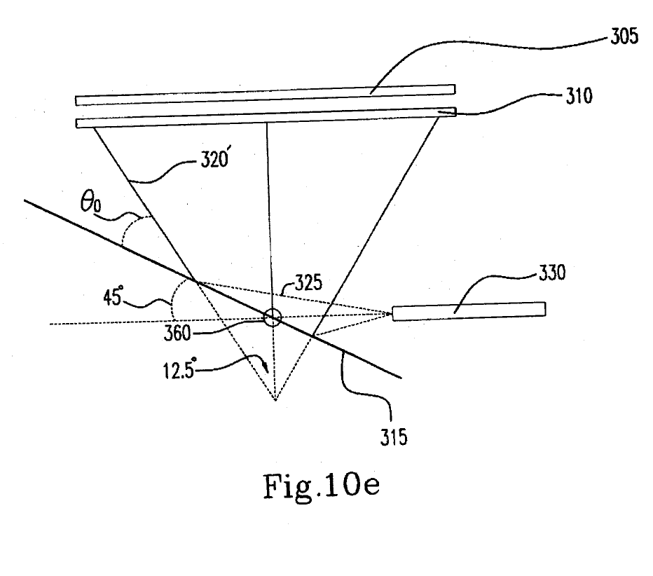

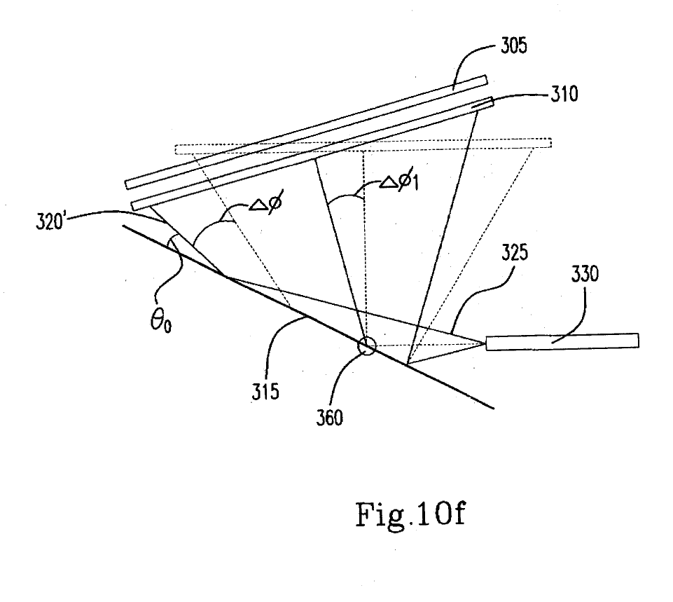

Referring to FIG. 10a for a sunlight tracking system of this invention. The sunlight tracking system includes a base 270 for supporting a light collector 280 on a rotational shaft 275. In order to optimize the efficiency of sunlight collection, the sunlight collection base 270 and the sunlight collector 280 are provided to have rotational flexibility along at least two of the three different axes shown as X-Y-Z axes. In a preferred embodiment, the base 270 can rotate along a Z-axis while the sunlight collector 280 is provided to rotate along an X-axis. The rotation of the base 270 and the collector 280 are provided to tracking and focusing on the sun at different time of the day as the earth rotates and moves around the sun. A motor (not shown) is employed to actuate the rotation of the sunlight tacking system base 270 and the motor is controlled and driven by a sunlight collection guiding means (not shown) that includes a processor executing a program using astronomical data that includes the location of the sunlight collection system, the equatorial coordinates and the date and time of sunlight collection to determine an optimal orientation of the sunlight collector. The sunlight collection guiding means further includes a real time feedback system receiving a, real-time sunlight collection data obtained directly from the sunlight collector to further fine tune and adjust the orientations of the base and the collector to optimize the collection of the energy received from the sun.

FIG. 10b shows another optical energy collection system 300 of this invention implemented with a Frensel lens 305 coated with an infrared (IR) filter 310. The IR filter 310 can be coated onto the Frensel lens 305. The Frensel lens focus the sunlight 320 onto a mirror 315 for reflecting the reflected beam 325 onto an optical fiber 330. The Frensel lens 305 and the IR filter 310 are supported and fixed on a rotational frame 350 that are rotatable around a rotation pivot360. The mirror 315 is also rotational around the rotation pivot 360. FIGS. 10c and 10d show the relative rotation angle between the Frensel lens and the mirror 315 at different times of the day where the Frensel lens 305 and the IR filter 310 are tracking the sun for the purpose of collecting maximum amount of optical energy. In the meantime, the mirror 315 is rotated relative to the rotation of the Frensel lens 315 to reflect the collected sunlight onto the optical fiber 330. FIGS. 10e and 10F show a functional relationship between the angular rotations of the mirror 315 and the Frensel lens 305. FIG. 10e shows the angular position of the mirror 315 at noon time when the sunlight is projected vertically unto the Frensel lens and there is an incline angle of θ₀ between the mirror 315 the direction of a focused beam 320′ projected from the edge of the Frensel lens 305. In FIG. 10f, the Frensel lens 305 rotates Δφ, while the angle θ₀′ between the mirror 315 and the focused beam 320′ projected from the edge of the Frensel lens 305 must be greater than zero degree. Meanwhile, as the Frensel lens 305 is rotated Δφ degree, the mirror 315 must rotate Δφ/2. Therefore, θ₀−Δφ+(Δφ/2)>0 and the maximum angular rotation allowable for the Frensel lens is: Δφ<2θ₀. The maximum allowable rotation of the Frensel lens is 2θ₀ and the maximum allowable rotation angle of the mirror 330 is θ₀. Meanwhile, for the purpose of improving the optical energy collection, the optical fiber 330 is formed as a tapered rod having a larger end area facing the mirror 315 and gradually reduces in the cross sectional area for coupling to a regular optical fiber to transmit the collected optical energy to an optical engine whereby the sunlight collecting system can achieve a function as an optical light source.

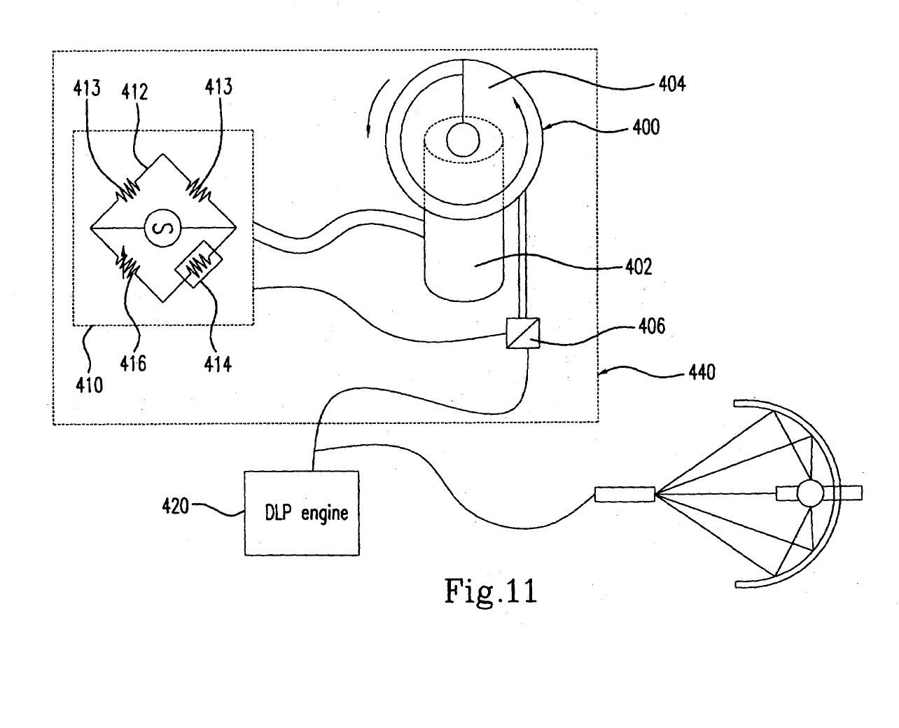

Referring to FIG. 11 for a sunlight regulating and control system 440 of this invention. A light luminance detector 410, e.g., Wheatstone Bridge having conductive lines 412 connected two resistors 413 and a variable resistor 416 and a photoconductive cell 414 is employed for detecting luminance of light to generate a signal corresponding to the luminance of the detected light. A light luminance selector 400 that includes a motor 402 and a disk 404 having different levels of transparency is implemented for proving different levels of light luminance filter corresponding to the signal of light luminance detector 410. A light splitter 406 to reflect 10% of the sunlight to a luminance detector 410, e.g., the Wheatstone Bridge and a photoconductive cell 414, for detecting the luminance of sunlight, and 90% of the sunlight is transmitting to DLP engine. When the luminance of sunlight is under a preset value where a variable resistor is implemented to set the preset luminance value, a motor 402 is employed to drive a disk 404 to a proper level of transparency to regulate the sunlight transmission to the DLP engine 420.

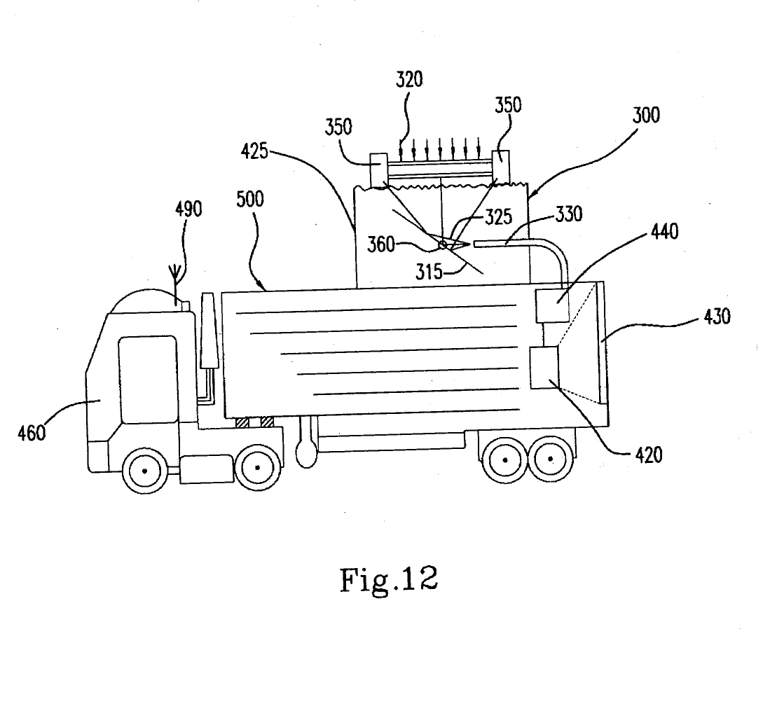

FIG. 12 shows a new configuration for a mobile display system 500 of this invention implemented with the optical energy collection system 300 and a sunlight energy collector shown in FIGS. 1 to 11 above. The mobile display system is carried on a motor vehicle 460 that has a back area implemented as a display area 430 for displaying images using image signals received from a wireless signal receiver 490 supported on the motor vehicle 460. The motor vehicle 460 further carries and supported on a sunlight energy collector 300 on a platform 425 to transmit the sunlight energy via an optical fiber optical transmitting cable 330 to a light luminance controller 440 and a DLP engine 420 for providing light source to a display system (not shown) also carried on the motor vehicle 460. The motor vehicle 460 may also include a side sliding door 470 to slid up and down for the purpose of either using the image display screen 430 for display when the sliding door is pulled up or to cover and protect the image display 430 when the sliding side door is pulled down. The platform 425 may also be controlled by a motor (not shown) to lift up to the top of the motor vehicle as shown for collecting sunlight energy or pulled down and enclosed inside the trailer of the motor vehicle 460 for protection and for transporting to different geographical locations for the purpose of outdoor display.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. An optical energy collecting system for providing optical power to a display system for showing an image, the optical energy collection system comprising:
an optical energy collecting system for collecting optical energy from a background illumination source surrounding and illuminating on said display system whereby an optical energy provided by said optical energy collecting system to said display system for illumination is naturally adjusted according to a background illumination of said background surrounding said display system.

2. The optical energy collecting system of claim 1 wherein:
said optical energy collecting system comprising a sunlight optical radiation collecting system for collecting optical energy from a background illumination sunlight as said background illumination source.

3. The optical energy collecting system of claim 2 wherein:
said sunlight optical radiation collecting system further includes a parabolic reflector for reflecting and focusing sunlight from said background illumination sunlight to an optical collecting port.

4. The optical energy collecting system of claim 2 further comprising:
a complimentary optical energy collecting system for collecting optical energy from a complimentary optical source for complementing optical energy collected from said background illumination sunlight.

5. The optical energy collecting system of claim 4 wherein:
said complimentary optical energy collecting system further includes a lamp and an elliptic reflector for reflecting and focusing optical radiation emitted from said lamp to an optical collecting port.

6. The optical energy collecting system of claim 2 wherein:
said sunlight optical radiation collecting system further includes a pa Frensel lens for focusing sunlight from said background illumination sunlight to an optical collecting port.

7. The optical energy collecting system of claim 2 further comprising:
a rotatable base for supporting said sunlight optical radiation collecting system for rotating said sunlight optical radiation collecting system to optimally collect said optical energy.

8. The optical energy collecting system of claim 1 further comprising:
a outdoor display means for connecting to said optical energy collecting system and applying said optical energy collected by said optical energy collecting system for outdoor image display.

9. The optical energy collecting system of claim 1 further comprising:
a mobile outdoor display means for supporting said optical energy collecting system and applying said optical energy collected by said optical energy collecting system for outdoor image display at different outdoor locations.

10. The optical energy collecting system of claim 1 further comprising:
a trailer display means disposed on a trailer truck with an outdoor display surface wherein said trailer truck supporting said optical energy collecting system and applying said optical energy collected by said optical energy collecting system for outdoor image display on said display surface at different outdoor locations.

11. A method for collecting optical energy for providing optical power to a display system for showing an image, the optical energy collection system comprising:
collecting optical energy from a background illumination source surrounding and illuminating on said display system by employing an optical energy collecting system whereby an optical energy provided by said optical energy collecting system to said display system for illumination is naturally adjusted according to a background illumination of said background surrounding said display system.

12. An optical energy collecting system for collecting optical energy from a sunlight further comprising:
a sunlight tracking system for guiding and moving a sunlight collector to an optimal sunlight collecting orientation.

13. The optical energy collecting system of claim 12 further comprising:
a sunlight regulating system for sensing and controlling an amount of sunlight energy transmitted to a display engine.

14. The optical energy collecting system of claim 13 wherein:
said sunlight regulating system further comprising a transparency varying means for varying a transparency for transmitting a variable amount of sunlight energy to said engine.

15. The optical energy collecting system of claim 12 wherein:
said sunlight tracking system further includes a rotational base for supporting and rotating said sunlight collector along different rotational axes for guiding and moving said sunlight collector to an optimal sunlight collecting orientation.

16. The optical energy collecting system of claim 12 wherein:
said sunlight collector further includes a parabolic reflector for reflecting and focusing sunlight from said background illumination sunlight to an optical collecting port.

17. The optical energy collecting system of claim 12 further comprising:
a complimentary optical energy collecting system for collecting optical energy from a complimentary optical source for complementing optical energy collected by said sunlight collector

18. The optical energy collecting system of claim 17 wherein:
said complimentary optical energy collecting system further includes a lamp and an elliptic reflector for reflecting and focusing optical radiation emitted from said lamp to an optical collecting port.

19. The optical energy collecting system of claim 12 wherein:
said sunlight collector further includes a Frensel lens for focusing a sunlight to an optical collecting port.

20. The optical energy collecting system of claim 12 further comprising:
a mobile outdoor display means for supporting said sunlight collector and applying said optical energy collected by said sunlight collector for outdoor image display at different outdoor locations.
